(19) United States
(12) Patent Application Publication
(10) Pub. No.: US 2010/0166047 A1
(43) Pub. Date: Jul. 1, 2010

(54) METHOD FOR DETECTING SATELLITE NAVIGATION RECEIVED SIGNAL AND APPARATUS THEREOF

(75) Inventors: Byung Doo KIM, Daejeon (KR); Youngsu CHO, Seoul (KR); Seong Yun CHO, Daejeon (KR); Sung Jo YUN, Daejeon (KR); Sun-Joong KIM, Daejeon (KR); Wan Sik CHOI, Daejeon (KR); Jong-Hyun PARK, Daejeon (KR); Luis Enrique Aguado, Leeds (GB); Yeqiu Ying, Saltaire (GB)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/610,803

(22) Filed: Nov. 2, 2009

(30) Foreign Application Priority Data
Dec. 29, 2008 (KR) 10-2008-0135219
Apr. 29, 2009 (KR) 10-2009-0037750

(51) Int. Cl. H04B 1/707

(52) U.S. Cl. 375/150; 375/E01.002

(57) ABSTRACT

Provided are a method for detecting a received signal and an apparatus for detecting a satellite navigation received signal using the same. The present invention provides cells where a correlation value obtained through parallel signal detection is a predetermined signal detection threshold value or more are selected and time domain correlation is performed on the cells so that the correlation value is verified. The cells having the predetermined verified threshold value or more are detected as a final received signal.

### CROSS-REFERENCE TO RELATED APPLICATION

This application claims priority to and the benefit of Korean Patent Application Nos. 10-2008-0135219 and 10-2009-0037750 filed in the Korean Intellectual Property Office on Dec. 29, 2008 and Apr. 29, 2009, the entire contents of which are incorporated herein by reference.

### BACKGROUND OF THE INVENTION

(a) Field of the Invention

The present invention relates to a method for detecting a received signal and an apparatus for detecting a satellite navigation received signal using the same. The present invention relates to an apparatus for detecting a GNSS signal by performing parallel correlation and a method thereof, in a global navigation satellite system (hereinafter collectively referred to as “GNSS”) receiver.

(b) Description of the Related Art

A global navigation satellite system (GNSS) receiver, such as a global positioning system (GPS), Galileo, GLONASS, and Beidou navigation system (COMPASS) can calculate its own position from at least four pseudoranges (a distance from a GNSS satellite to a GNSS receiver) and a position of a GNSS satellite.

The GNSS receiver estimates a time of arrival by comparing signals originating from several GNSS satellites with internally generated demodulation signals in order to measure a distance between the satellite and the receiver. A process of calculating the time of arrival from the GNSS satellite signal starts detecting signals from visible satellites in an environment that causes various error factors, such as thermal noise of a receiver, an oscillator error, a Doppler shift due to a relative movement of a satellite and a receiver, interference between pseudo-random numbers (PRNs), etc.

A method for detecting a GNSS signal may be sorted into a serial search method that sequentially searches the received signals for each PRN of the GNSS satellite in a time domain, and a parallel search method that searches the received signals in parallel by using a method such as an FFT-IFFT in a frequency domain.

A correlator using the sequential search has been mainly used in a hardware-based GNSS receiver. Since the correlator using the parallel search provides correlation values for all the search cells by calculating a time delay and a frequency offset at one time, the parallel search method has been used as an efficient search method in a software-based GNSS receiver.

When signal attenuation is largely caused near a high-rise building of a city, or in a tunnel, a room, etc., a highly-sensitive GNSS receiver integrates signal correlation values during several periods of the PRN of the GNSS satellite by a coherent scheme, a non-coherent scheme, a combination scheme thereof, etc., in order to increase a signal to noise ratio (SNR).

The coherent scheme can obtain a larger SNR than the non-coherent scheme, but significantly increases a frequency bandwidth to be searched.

Further, the integration method using the coherent scheme limits the correlation period by modulation of the PRN code by navigation data or modulation by a secondary code. Generally, in order to avoid the integration in the case where signs are opposite to each other, a modulation symbol should coincide at all times.

When the modulation symbol is not known, the integration of the coherent scheme calculates a sum of the correlation values for combinations of symbol values, respectively, over an extended period, and can be extended over a plurality of modulation symbols by selecting the highest correlation value.

The number of combinations of tested modulation symbols is squared or takes an absolute value to remove the sign of the correlation value, such that it can be reduced to a half.

The non-coherent integration of several periods for the foregoing coherent correlation matrix can increase the SNR, but can be limited due to user movement or a local oscillator error.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in effort to provide a method for detecting a weak GNSS signal using a verification procedure for correlation results, and an apparatus thereof.

An exemplary embodiment of the present invention provides a method for detecting a received signal by a satellite navigation receiver using parallel correlation, including: selecting cells where a correlation value obtained through parallel signal detection is a predetermined signal detection threshold value or more and performing time domain correlation on the cells to verify the correlation value; and detecting cells having a predetermined verified threshold value or more as a final received signal.

Another embodiment of the present invention provides an apparatus for detecting a satellite navigation received signal using parallel correlation, including: a verifier that verifies a correlation value by performing time domain correlation on cells where the correlation value obtained through parallel signal detection is the predetermined signal detection threshold value or more; and a detector that detects cells having a predetermined verified threshold value or more as a final received signal.

### BRIEF DESCRIPTION OF THE DRAWINGS

FIG. 1 is a block diagram showing a constitution of a satellite navigation received signal detection apparatus according to an exemplary embodiment of the present invention.

FIG. 2 is a flowchart showing a method for detecting a received signal according to an exemplary embodiment of the present invention.

FIG. 3 is a flowchart showing a process of selecting candidate cells according to an exemplary embodiment of the present invention.

FIG. 4 is a graph showing a comparison of signal detection probability according to the first exemplary embodiment of the present invention.

FIG. 5 is a graph showing a comparison of signal detection probability according to the second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification and claims, unless explicitly described to the contrary, the word “comprise” and variations such as “comprises” or “comprising” will be understood to imply the inclusion of stated elements but not the exclusion of any other elements.

Hereinafter, a method for detecting a received signal and an apparatus for detecting a satellite navigation received signal using the same will be described in detail with reference to the accompanying drawings.

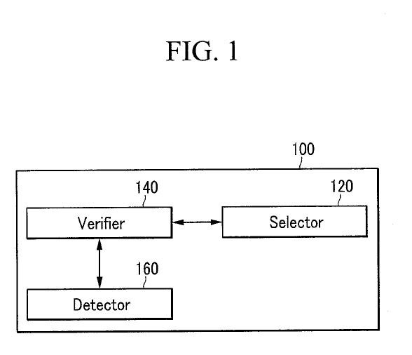

First, FIG. 1 is a block diagram showing a constitution of a satellite navigation received signal detection apparatus according to an exemplary embodiment of the present invention.

Referring to FIG. 1, the satellite navigation received signal detection apparatus 100 detects a signal using a correlator using parallel search. Since the correlator using the parallel search provides correlation values for all search cells by calculating a time delay and a frequency offset at a time, the correlator using the parallel search has been used as an efficient search method in a software-based global navigation satellite system (hereinafter collectively referred to as “GNSS”) receiver.

The satellite navigation received signal detection apparatus 100 includes a selector 120, a verifier 140, and a detector 160.

The selector 120 selects verified candidate cells. In other words, the selector 120 aligns the cells where the correlation value that is calculated by performing the parallel correlation between the received signal and a reference signal is the predetermined signal detection threshold value or more according to a magnitude of the correlation value. The selector 120 groups the aligned cells according to a code delay and a frequency bin to select verified candidate cells for time domain correlation.

The verifier 140 determines that there is no signal when the correlation value is below the signal detection threshold value. When the correlation value is the signal detection threshold value or more, the verifier 140 verifies the correlation value by performing time domain correlation on the verified candidate cells selected by the selector 120. At this time, the verifier 140 calculates a non-coherent integration value for the verified candidate cells to perform the time domain correlation.

The detector 160 detects the cells where the time domain correlation value verified by the verifier 140 is the predetermined verified threshold value or more as a final received signal. In other words, when the non-coherent integration value calculated by the verifier 140 is below the verified threshold value, the detector 160 outputs a false alarm. When the non-coherent integration value is the verified threshold value or more, the detector 160 outputs the cells where the non-coherent integration value exceeds the verified threshold value as a signal detection result.

A specific signal detection process of the satellite navigation received signal detection apparatus 100 will be described in detail.

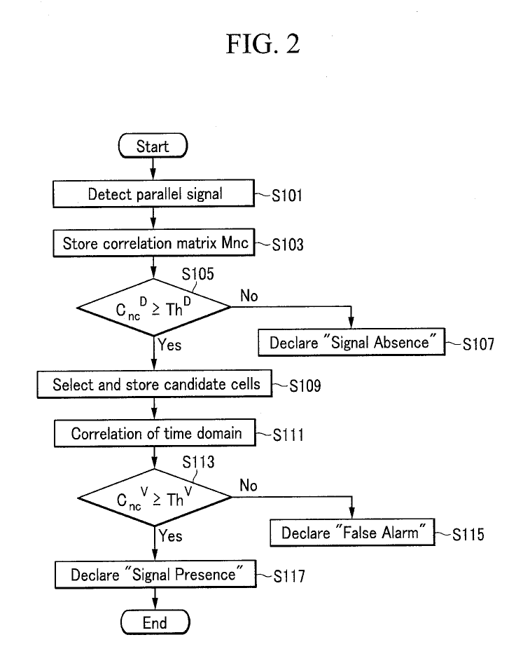

FIG. 2 is a flowchart showing a method for detecting a received signal according to an exemplary embodiment of the present invention.

Referring to FIG. 2, the verifier 140 of FIG. 1 stores correlation matrix M_{nc} generated through a process of detecting a parallel signal S101 (S103). In other words, the verifier 140 integrates the coherent correlation value of the actually received signal and the signal generated from the inside of the receiver using a general method for obtaining a signal using parallel search in a non-coherent scheme for an N period, thereby generating a three-dimensional correlation matrix M_{nc}. At this time, the coherent correlation value includes a code delay, a frequency offset, and a modulation symbol delay.

Herein, when there is an actual global navigation satellite system (GNSS) satellite signal corresponding to the signal generated from the inside of the receiver, the correlation matrix M_{nc} is calculated as follows.

$${C}_{nc}^{D} ( {s}_{e ,} {τ}_{c} , {f}_{b} ) = {C}_{I} ( {s}_{e} , {τ}_{c} , {f}_{b} ) + {C}_{Q} ( {s}_{e} , {τ}_{c} , {f}_{b} ) \\ {C}_{I} ( {s}_{e} , {τ}_{c} , {f}_{b} ) = {\sum }_{m = 1}^{{N}_{nc}} {\vert {A}_{m} {L}_{{S}_{e}} R ( {Δτ}_{e , m} ) \frac{sin ( πΔ {f}_{m} {T}_{coh} )}{πΔ {f}_{m} {T}_{coh}} cos ( {θ}_{e , m} ) + {N}_{I , m} \vert}^{ix} \\ {C}_{Q} ( {s}_{e} , {τ}_{c} , {f}_{b} ) = {\sum }_{m = 1}^{{N}_{nc}} {\vert {A}_{m} {L}_{{S}_{e}} R ( {Δτ}_{e , m} ) \frac{sin ( πΔ {f}_{m} {T}_{coh} )}{πΔ {f}_{m} {T}_{coh}} sin ( {θ}_{e , m} ) + {N}_{Q , m} \vert}^{ix} \qquad ( Equation 1 )$$

Herein, C_{nc}^{D} represents a correlation value, Sₑ represents a modulation symbol edge, τ_{c} represents a code delay, f_{b} represents a frequency bin, Aₘ in represents an average amplitude of signals received during the time of T_{coh}^{D}, Lₛₑ represents a signal loss generated due to inconsistency of modulation symbols, R(•) represents a self-correlation function for a PRN code of a GNSS satellite, Δτ_{e,m} represents inconsistency of average code phase during the time of T_{coh}, Δfₘ represents inconsistency of average frequency during the time of T_{coh}, θ_{e,m} represents an error for carrier phase, and N_{I,m} and N_{Q,m} represent noise for in-phase and quadrature signals. ix may also be differently set to the same value as 1 or 2.

At this time, the average of correlation loss for the offset of the symbol edge may be represented by the following.

Lₛₑ=20×log₁₀(2kTₛₑ/T_{symbol}) (Equation 2)

Herein, k represents the number of symbol periods, Tₛₑ represents the offset of a symbol, and T_{symbol} represents the period of the symbol.

In the received signal having a low signal to noise ratio (SNR), the noise may generate a plurality of cells exceeding the signal detection threshold value.

The correlation value (C_{nc}^{D}) for the code delay (τ_{c}), the frequency bin (f_{b}), and the modulation symbol edge (Sₑ) is stored in the three-dimensional matrix M_{nc} calculated using the equations.

At this time, the verifier 140 determines whether the stored correlation value (C_{nc}^{D}) is the signal detection threshold value Th^{D} or more (S105).

As a result of the determination, when there is no correlation value (C_{nc}^{D}) that is a signal detection threshold value Th^{D} or more, the detector 160 of FIG. 1 declares signal absence (S107).

As a result of the determination, when there is the correlation value (C_{nc}^{D}) that is the threshold value Th^{D} or more, the selector 120 of FIG. 1 selects and stores candidate cells for verifying the correlation value (S109).

The verifier 140 generates an internal demodulation signal using information of each cell included in the candidate cells and performs correlation in a time domain (S111). The correlation in the time domain is performed as follows.

The information of the code delay (τ_{c}) and the frequency bin (f_{b}) for each candidate cell group is used for matching the demodulation signal inside the receiver in order to verify the candidate cells.

The coherent correlation values of the (N_{nc}+1)×Nₛₑ−1 block successive for Nₛₛₑ samples are calculated using the following equation.

$${{C}_{Nse} ( {τ}_{c} , {f}_{b} )}_{i} = {\sum }_{n = i \times ( {N}_{sse} - 1 )}^{i \times {N}_{sse} - 1} r ( {τ}_{c} + n ) [ {I}_{L} ( {τ}_{c} + n , {f}_{b} ) + j {Q}_{L} ( {τ}_{c} + n , {f}_{b} ) ] \qquad ( Equation 3 )$$

Herein, Nₛₑ represents the number of symbol edge delays in the symbol period (T_{symbol}), and Nₛₛₑ=T_{symbol}×Rₛ/Nₛₑ represents the number of samples between the symbol edge delays.

Rₛ represents a sample period of the receiver. i ranges from 1 to (N_{nc}+1)×Nₛₑ−1, and r represents the vector of the received signal.) The coherent integration value (Cₘₛ) is also calculated by the following equation, for each symbol edge (Sₑ) selected from the current cell group.

$${{C}_{ms} ( {s}_{e} , {τ}_{c} , {f}_{b} )}_{1} = {\sum }_{k = l \times ( {N}_{se} - 1 ) + {s}_{e}}^{l \times {N}_{se} + {s}_{e} - 1} \vert {( ℜ ( {{C}_{Nse} ( {τ}_{c} , {f}_{b} )}_{k} ) )}^{ix} + {( ( {{C}_{Nse} ( {τ}_{c} , {f}_{b} )}_{k} ) )}^{ix} \vert \qquad ( Equation 4 )$$

Herein, I ranges from 1 to Nₜ^{(V)}×N_{nc}, and [symbol] (•) and ℑ(•) represent operations for a real number and an imaginary number, respectively.

For the coherent integration for the Nₜ^{V} period where the symbol is not known, estimation for the combinations of symbols is required in order to unify the modulation symbols over each coherent period (T_{coh}^{V}) in the range of Nₜ^{V}≧1.

The entire marks for the coherent correlation period are removed by the |•|^{ix} operation so that 2^{N}^{ₜ}^{^{V}}⁻¹ combinations of symbols for the correlation value between Nₜ^{V} and Cₘₛ(sₑ, τ_{c}, f_{b}) are available.

The coherent correlation for the combinations of symbols of s_{c}, C_{sc}(s_{c}, sₑ, τ_{C}, f_{b}) is calculated by the following equation.

$${{C}_{sc} ( {s}_{c} , {s}_{e} , {τ}_{c} , {f}_{b} )}_{c} = {\vert {\sum }_{p = 1}^{{N}_{t}} v ( {s}_{c} , p ) \times ℜ ( {{C}_{ms} ( {s}_{e} , {τ}_{c} , {f}_{b} )}_{c \times {N}_{t} + p} ) \vert}^{ix} + \vert {\sum }_{p = 1}^{{N}_{t}} v ( {s}_{c} , p ) \times ( {{C}_{ms} ( {s}_{e} , {τ}_{c} , {f}_{b} )}_{c \times {N}_{t} + p} ) \vert \qquad ( Equation 5 )$$

Herein, v(s_{c}, p) represents a modulation pattern for evaluating the combinations of symbols.

The combination of symbols having the highest correlation value is selected, and the non-coherent integration C_{nc}^{V} is calculated as follows.

$${{C}_{Tcoh} ( {s}_{e} , {τ}_{c} , {f}_{b} )}_{c} = max \{ {{C}_{sc} ( {s}_{c} , {s}_{e} , {τ}_{c} , {f}_{b} )}_{c} \} \\ {C}_{nc}^{V} ( {s}_{e} , {τ}_{c} , {f}_{b} ) = {\sum }_{c = 1}^{{N}_{nc}} {{C}_{Tcoh} ( {s}_{e} , {τ}_{c} , {f}_{b} )}_{c} \qquad ( Equation 6 )$$

As described above, the verifier 140 performs the non-coherent integration for all the cells included in the verified candidate cells. The verifier 140 compares the result of the non-coherent integration (C_{nc}^{V}) with the predetermined, verified threshold value (Th^{V}) (S113).

At this time, when the result (C_{nc}^{V}) of the non-coherent integration does not exceed the verified threshold value (Th^{V}) that is, when there is no cell that exceeds the verified threshold value (Th^{V}) the detector 160 declares False Alarm (S115).

However, when the result (C_{nc}^{V}) of the non-coherent integration is the verified threshold value (Th^{V}) or more, the detector 160 declares that there is a signal (Signal Presence) (S117).

At this time, when there is one cell that exceeds the verified threshold value (Th^{V}) the cell is selected as a final candidate cell.

When a plurality of cells exceed the verified threshold value (Th^{V}) the non-coherent estimated value is the same as C_{nc}^{D}+C_{nc}^{V}. The cell having the maximum correlation value, that is, the cell of which C_{nc}^{D}+C_{nc}^{V} is the greatest, is output as a signal detection result.

Herein, the step S109 will be described in more detail.

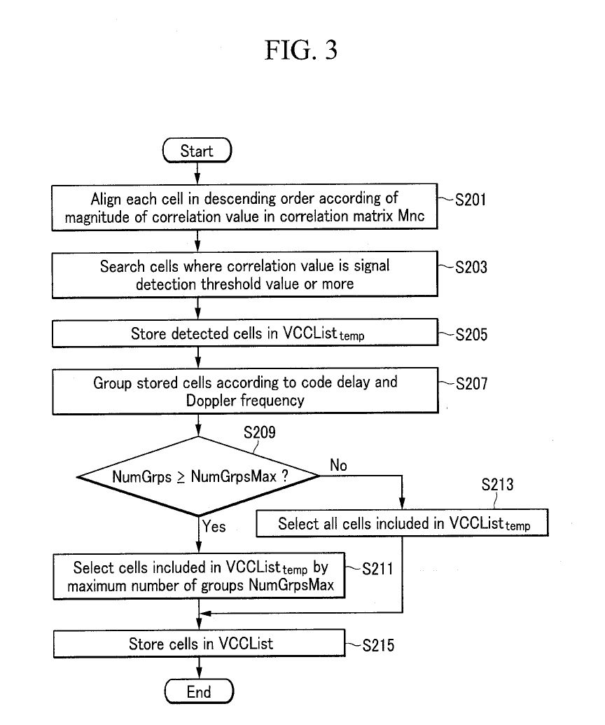

FIG. 3 is a flowchart showing a process of selecting candidate cells according to an exemplary embodiment of the present invention.

Referring to FIG. 3, the selector 120 of FIG. 1 aligns each cell in descending order according to a magnitude of the correlation value (C_{nc}^{D}) in the three-dimensional correlation matrix M_{nc} stored in step S101 of FIG. 2 (S201).

The selector 120 searches the cells where the correlation value (C_{nc}^{D}) is the signal detection threshold value (Th^{V}) or more (S203) to store them in a VCCListₜₑₘₚ (S205).

Herein, the VCCList is a list where a code delay (τ_{c}), a frequency bin (f_{b}) a symbol edge (sₑ), a correlation value (C_{nc}^{D}), and a group number (grpNo) for the cells where the correlation value (C_{nc}^{D}) is the signal detection threshold value (Th^{D}) or more are stored. The information stored in the VCCList is used as information for generation a demodulation signal when performing the correlation in the time domain. The VCCListₜₑₘₚ is a temporary VCCList.

The selector 120 groups the cells stored in step S205 according to a code delay (τ_{c}) and a frequency bin (f_{b}) (S207). In other words, the cells are grouped according to the same code delay (τ_{c}) and frequency bin (f_{b}).

The selector 120 determines whether the number of groups NumGrps grouped in step S207 is the predetermined maximum number of groups NumGrpsMax or more (S209).

At this time, when the number of groups NumGrps is the predetermined maximum number of groups NumGrpsMax or more, the selector 120 selects the cells stored and included in the VCCListtemp in step S205 by the maximum number of groups NumGrpsMax (S211).

However, when the number of groups NumGrps is below the predetermined maximum number of groups NumGrpsMax, the selector 120 selects all the cells stored and included in VCCListtemp in S205 (S213).

The selector 120 stores the cells selected in step S211 or step S213 in the VCCList (S215).

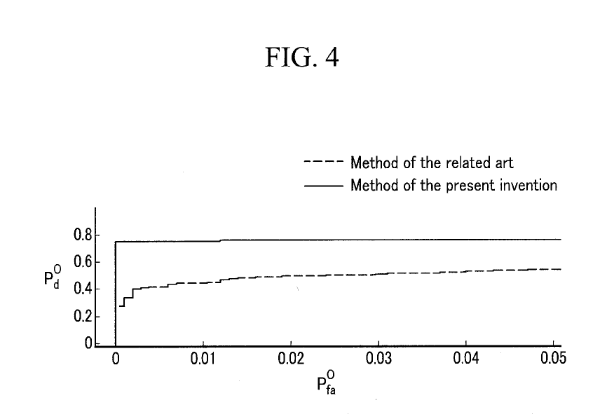

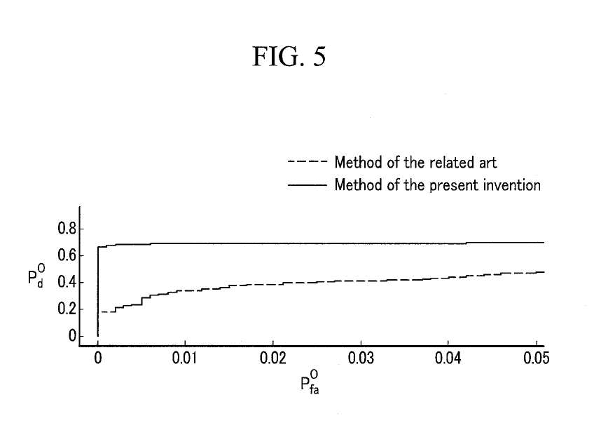

As described above, the cells exceeding the threshold value are selected as a subset and a sequential correlation is performed in a time domain for the extended period to perform verification on the correlation value (C_{nc}^{D}), thereby improving signal detection probability. The improvement in the signal detection probability may be confirmed through FIGS. 4 and 5.

FIGS. 4 and 5 are graphs showing comparisons of signal detection probabilities according to exemplary embodiments of the present invention.

Referring to FIGS. 4 and 5, the horizontal axis in the graph represents False Alarm Probability. The vertical axis in the graph represents detection probability.

At this time, FIG. 4 is a graph showing signal detection probability according to the first exemplary embodiment of the present invention, wherein the graph shows a comparison of signal detection probabilities between the detection method in the related art and the detection method according to the embodiment of the present invention in the case of carrier to noise ratio (CNR)=20 dB-Hz.

FIG. 5 is a graph showing signal detection probabilities according to the second exemplary embodiment of the present invention, wherein the graph shows a comparison of signal detection probabilities between the detection method in the related art and the detection method according to the embodiment of the present invention in the case of CNR=18 dB-Hz.

Referring to FIGS. 4 and 5, it can be appreciated that the detection probability according to the present invention is substantially higher than that in the related art. In other words, the performance of detecting a weak signal received together with noise is significantly improved.

According to the exemplary embodiment of the present invention adds a verification process of the correlation value to a signal detection process using parallel search in a GNSS receiver for receiving a weak GNSS signal, thereby increasing a signal detection probability in a given false alarm probability. Even when a correlation time is extended during a plurality of periods, complexity of the related operation can be lowered.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for detecting a received signal by a satellite navigation receiver using parallel correlation, comprising:
selecting cells where a correlation value obtained through parallel signal detection is a predetermined signal detection threshold value or more, and performing time domain correlation on the cells to verify the correlation value; and
detecting cells having a predetermined verified threshold value or more as a final received signal.

2. The method for detecting a received signal of claim 1, wherein the verifying includes:
calculating the correlation value by performing the parallel correlation between the received signal and a reference signal;
determining that there is no signal when the correlation value is below a signal detection threshold value;
selecting verified candidate cells when the correlation value is the signal detection threshold value or more; and
performing the time domain correlation on the verified candidate cells.

3. The method for detecting a received signal of claim 2, wherein the selecting includes:
aligning cells having a correlation value of the signal detection threshold value or more according to a magnitude of the correlation value;
grouping the aligned cells according to a code delay and a Doppler frequency;
determining whether the number of groups is a predetermined maximum number of groups or more;
when the number of groups is a predetermined maximum number of groups or more, selecting grouped cells as verified candidate cells by the maximum number of groups; and
when the number of groups is below the predetermined maximum number of groups, selecting all the grouped cells as verified candidate cells.

4. The method for detecting a received signal of claim 2, wherein
the performing of the time domain correlation includes:
calculating a coherent correlation value for combinations of symbol values estimated for the verified candidate cells; and
calculating a non-coherent integration value by selecting a combination of a symbol value having the highest coherent correlation value.

5. The method for detecting a received signal of claim 4, wherein the detecting of the cells includes:
comparing the non-coherent integration value with the predetermined verified threshold value;
when the non-coherent integration value is below the verified threshold value, outputting a false detection signal; and
when the non-coherent integration value is the verified threshold value or more, outputting the cells where the non-coherent integration value is the verified threshold value or more as a signal detection result.

6. The method for detecting a received signal of claim 5, wherein
the outputting the cells as the signal detection result includes:
when there is one cell where the non-coherent integration value is the verified threshold value or more, outputting the cell having the verified threshold value or more as a signal detection result; and
when there are a plurality of cells where the non-coherent integration value is the verified threshold value or more, outputting a cell having a maximum sum of a correlation value obtained through parallel signal detection and the non-coherent integration value as a signal detection result.

7. An apparatus for detecting a satellite navigation received signal using parallel correlation, comprising:
a verifier that verifies a correlation value by performing time domain correlation on cells where the correlation value obtained through parallel signal detection is the predetermined signal detection threshold value or more; and
a detector that detects cells having the predetermined verified threshold value or more as a final received signal.

8. The apparatus for detecting a satellite navigation received signal of claim 7, further comprising
a selector that aligns the cells where the correlation value that is calculated by performing the parallel correlation between the received signal and a reference signal is the predetermined signal detection threshold value or more according to a magnitude of the correlation value, groups the aligned cells according to a code delay and a Doppler frequency, and selects verified candidate cells for the time domain correlation.

9. The apparatus for detecting a satellite navigation received signal of claim 8, wherein the selector groups the aligned cells as cells having the same code delay and Doppler frequency, the selector selecting the grouped cells as the verified candidate cells by the maximum number of groups when the number of groups is the predetermined maximum number of groups or more, and the selector selecting all the grouped cells as the verified candidate cells when the number of groups is below the predetermined maximum number of groups.

10. The apparatus for detecting a satellite navigation received signal of claim 8, wherein the verifier determines that there is no signal when the correlation value is below the signal detection threshold value, and performs the time domain correlation on the verified candidate cells when the correlation value is the signal detection threshold value or more.

11. The apparatus for detecting a satellite navigation received signal of claim 10, wherein the verifier calculates a coherent correlation value for combinations of symbol values estimated for the verified candidate cells and selects a combination of a symbol value having the highest coherent correlation value to calculate a non-coherent integration value.

12. The apparatus for detecting a satellite navigation received signal of claim 11, wherein the verifier outputs a false alarm when the non-coherent integration value is below the verified threshold value, and outputs the cells where the non-coherent integration value is the verified threshold value or more as a signal detection result when the non-coherent integration value is the verified threshold value or more.

13. The apparatus for detecting a satellite navigation received signal of claim 12, wherein the verifier outputs the cell having the verified threshold value or more as a signal detection result when there is one cell where the non-coherent integration value is the verified threshold value or more, and outputs a cell having a maximum sum of a correlation value obtained through parallel signal detection and the non-coherent integration value as a signal detection result when there are a plurality of cells where the non-coherent integration value is the verified threshold value or more.
